(19) United States
(12) Patent Application Publication
(10) Pub. No.: US 2026/0279090 A1
(43) Pub. Date: Sep. 17, 2026

(54) CHARACTER RECOGNITION SYSTEM, CHARACTER RECOGNITION METHOD, AND RECORDING MEDIUM

(71) Applicant: NEC Corporation, Tokyo (JP)

(72) Inventor: Junya AKIYAMA, Tokyo (JP)

(73) Assignee: NEC Corporation, Tokyo (JP)

(21) Appl. No.: 19/430,717

(22) Filed: Dec. 23, 2025

(30) Foreign Application Priority Data
Mar. 14, 2025 (JP) 2025-041816

(51) Int. Cl. G06V 30/194

(52) U.S. Cl. CPC G06V 30/194

(57) ABSTRACT

A character recognition system includes a recognition unit for recognizing a character included in an input image by using each of a plurality of character recognition models different from each other, a determination unit for determining any of a plurality of recognition results as a most likely recognition result by using a determination model based on the recognition result by each of the plurality of character recognition models and image feature information indicating a feature of the input image, a revision unit for revising the most likely recognition result based on a revision operation by a user, and a retraining unit for retraining the determination model by referring to training data including information indicating a revision content for the most likely recognition result, the plurality of recognition results, and the image feature information.

This application is based upon and claims the benefit of priority from Japanese Patent Application No. 2025-041816, filed on Mar. 14, 2025, the disclosure of which is incorporated herein in its entirety by reference.

### TECHNICAL FIELD

The present disclosure relates to a character recognition system, a character recognition method, and a recording medium.

### BACKGROUND ART

JP 2024-3769 A discloses a character recognition system that performs character recognition using a plurality of character recognition models having different characteristics. The character recognition system executes character recognition on an image of a character included in image data of a document by each character recognition model and generates character recognition result data of the entire document by combining results of the character recognition output by each character recognition model. The character recognition system retrains the character recognition model based on a correction result by the user.

### SUMMARY

The present disclosure has been made in view of the above problems, and an exemplary object thereof is to provide a technique for achieving retraining of a character recognition system using a plurality of character recognition models at low cost.

A character recognition system according to an example aspect of the present disclosure includes recognition means for recognizing a character included in an input image by using each of a plurality of character recognition models different from each other, determination means for determining any of a plurality of recognition results as a most likely recognition result by using a determination model based on the recognition result by each of the plurality of character recognition models and image feature information indicating a feature of the input image, revision means for revising the most likely recognition result based on a revision operation by a user, and retraining means for retraining the determination model by referring to training data including information indicating a revision content for the most likely recognition result, the plurality of recognition results, and the image feature information.

A character recognition method according to an example aspect of the present disclosure includes recognition processing of recognizing a character included in an input image by using each of a plurality of character recognition models different from each other by at least one processor, determination processing of determining any of a plurality of recognition results as a most likely recognition result by using a determination model based on the recognition result by each of the plurality of character recognition models and image feature information indicating a feature of the input image by the at least one processor, revision processing of revising the most likely recognition result based on a revision operation by a user by the at least one processor, and retraining processing of retraining the determination model by referring to training data including information indicating a revision content for the most likely recognition result, the plurality of recognition results, and the image feature information, by the at least one processor.

A character recognition program causes a computer to function as a character recognition system according to an example aspect of the present disclosure, and causes the computer functions as recognition means for recognizing a character included in an input image by using each of a plurality of character recognition models different from each other, determination means for determining any of a plurality of recognition results as a most likely recognition result by using a determination model based on the recognition result by each of the plurality of character recognition models and image feature information indicating a feature of the input image, revision means for revising the most likely recognition result based on a revision operation by a user, and retraining means for retraining the determination model by referring to training data including information indicating a revision content for the most likely recognition result, the plurality of recognition results, and the image feature information.

### BRIEF DESCRIPTION OF THE DRAWINGS

Exemplary features and advantages of the present disclosure will become apparent from the following detailed description if taken with the accompanying drawings in which:

FIG. 1 is a block diagram illustrating a configuration of a character recognition system according to the present disclosure;

FIG. 2 is a flowchart illustrating a flow of a character recognition method according to the present disclosure;

FIG. 3 is a block diagram illustrating a configuration of the character recognition system according to the present disclosure;

FIG. 4 is a diagram schematically illustrating a specific example of information to be referred to or generated in the character recognition system according to the present disclosure;

FIG. 5 is a flowchart illustrating a flow of a character recognition method according to the present disclosure;

FIG. 6 is a diagram illustrating an example of a screen according to the present disclosure;

FIG. 7 is a diagram illustrating an example of the screen according to the present disclosure;

FIG. 8 is a block diagram illustrating a configuration of the character recognition system according to the present disclosure; and

FIG. 9 is a block diagram illustrating a hardware configuration of a computer that functions as each device according to the present disclosure.

### EXAMPLE EMBODIMENT

Hereinafter, example embodiments of the present disclosure are exemplified.

However, the present disclosure is not limited to the following example embodiments, and various modifications can be made within the scope of the claims. For example, example embodiments obtained by appropriately combining techniques (some or all of the objects or methods) adopted in the following example embodiments can also be included in the scope of the present disclosure. Example embodiments obtained by appropriately omitting some of the techniques adopted in the following example embodiments can also be included in the scope of the present disclosure. The effects mentioned in the following example embodiments are examples of effects expected in the example embodiments and do not define the extension of the present disclosure. That is, example embodiments that do not exhibit the effects mentioned in the following example embodiments can also be included in the scope of the present disclosure.

### First Example Embodiment

A first example embodiment that is an example of the example embodiments of the present disclosure is described in detail with reference to the drawings. The present example embodiment is a basic form of the following example embodiments. An application range of each technique adopted in the present example embodiment is not limited to the present example embodiment. That is, each technique adopted in the present example embodiment can also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Character Recognition System 1

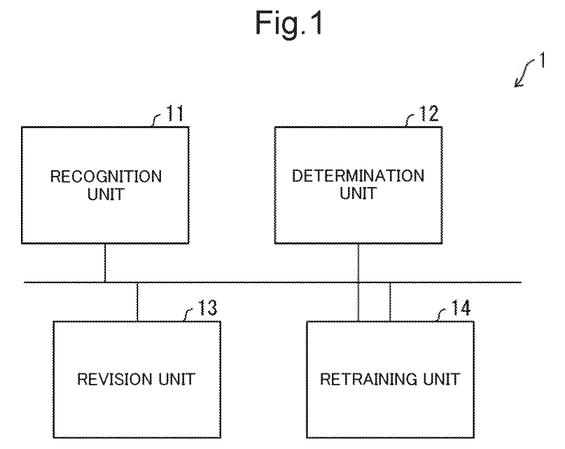

A configuration of a character recognition system 1 is described with reference to FIG. 1. FIG. 1 is a block diagram illustrating a configuration of the character recognition system 1. As illustrated in FIG. 1, the character recognition system 1 includes a recognition unit 11, a determination unit 12, a revision unit 13, and a retraining unit 14. The recognition unit 11 is an example of a configuration that implements a recognition means. The determination unit 12 is an example of a configuration that implements determination means. The revision unit 13 is an example of a configuration that implements a revision means. The retraining unit 14 is an example of a configuration that implements a retraining means.

The recognition unit 11 recognizes characters included in the input image using a plurality of character recognition models different from each other. Each character recognition model includes a model learned by machine learning in such a way as to output a recognition result including character information with an input image as an input. For example, each character recognition model may include a neural network model or may include a model using another machine learning algorithm. The input image includes one or more characters. The character information included in a recognition result may indicate one or more character codes. The recognition result may include a recognition score in addition to character information. The recognition score indicates a probability (certainty factor) that the character information is correct.

The “plurality of character recognition models different from each other” may be, for example, character recognition models learned by machine learning algorithms different from each other. For example, the “plurality of character recognition models different from each other” may be character recognition models that perform preprocessing different from each other on the input image. The preprocessing may be, for example, binarization, smoothing, ruled line removal, a change of an aspect ratio, a change of resolution, a change of a luminance value, or a combination of some or all of these, but is not limited thereto. For example, the “plurality of character recognition models different from each other” may be models learned using training data sets at least partially different from each other. For the same input image, recognition results from a plurality of character recognition models different from each other may be different from each other.

For example, an example is described in which a plurality of character recognition models for recognizing a mathematical numeral included in an image of an envelope of mail is used. In this example, a certain character recognition model among the plurality of character recognition models may have learned an image of an envelope of a domestic mail as a training data set, and another character recognition model may have learned an image of an envelope from overseas as a training data set. However, the plurality of character recognition models different from each other is not limited to the above-described example.

Based on the recognition result by each of the plurality of character recognition models and the image feature information indicating the feature of the input image, the determination unit 12 determines any of the plurality of recognition results as a most likely recognition result using a determination model. For example, the determination model includes a model learned by machine learning in such a way that a plurality of recognition results and image feature information are input and any of the plurality of recognition results is output as a most likely recognition result. For example, the determination model may include a neural network model or may include a model using another machine learning algorithm. The most likely recognition result may include a determination score in addition to any of the plurality of recognition results. The determination score indicates a probability (certainty factor) that the recognition result regarded as a most likely recognition result is correct. For example, the determination model may calculate a determination score for each of the plurality of recognition results and output a recognition result having the highest determination score as a most likely recognition result.

The “image feature information” is information indicating a feature of the input image and is extracted from the input image.

Examples of the feature that can be extracted include a feature based on a characteristic of a pixel, a feature related to a shape or a position, and a feature of a character. Examples of features based on characteristics of the pixel include resolution, brightness statistics (for example, an average value or a standard deviation), out-of-focus scores (for example, dispersion of an image to which a Laplacian differential filter is applied), and the number of black blocks upon image data is binarized. Examples of features related to a shape or a position include an aspect ratio of an image and a position of an element (for example, ruled lines, frame lines, figures, numbers, and characters) included in the image in the image. Examples of the features of the character include the type of language (Japanese, English, or Chinese) of the character included in the image, the type of form (hiragana, katakana, kanji, and the like) of the character, and the number of specific characters (for example, the number of “0” in the character string). However, the image feature information is not limited to the above-described example.

The revision unit 13 revises the most likely recognition result based on a revision operation by the user. For example, the revision operation by the user includes an operation of revising character information included in the most likely recognition result. For example, the character information included in the most likely recognition result is displayed on a display device (not illustrated) in a mode capable of accepting a revision operation. The revision operation for the character information is performed using an input device (not illustrated).

The retraining unit 14 retrains the determination model by referring to the training data including the information indicating the revision content for the most likely recognition result, the plurality of recognition results, and the image feature information. For example, the information indicating the revision content at least includes revised character information obtained by revising the character information included in the most likely recognition result. The information indicating the revision content may further include character information included in the most likely recognition result, that is, unrevised character information. For example, the retraining unit 14 may retrain the determination model in such a way as to output a recognition result relevant to the revised character information as a most likely recognition result with respect to the input of the plurality of recognition results and the image feature information. For example, the retraining unit 14 may retrain the determination model in such a way that the determination score in a case where the recognition result relevant to the unrevised character information is determined to be a most likely recognition result with respect to the input of the plurality of recognition results and the image feature information is lowered as compared with that before retraining. For example, the retraining unit 14 may retrain the determination model in such a way that the determination score in a case where the recognition result relevant to the revised character information is determined to be a most likely recognition result with respect to the input of the plurality of recognition results and the image feature information is increased as compared with that before retraining. In the retraining, it is desirable to refer to a plurality of training data different from each other. The retraining may be additional training or may be new training.

### Effect of Character Recognition System 1

As described above, the character recognition system 1 adopts a configuration including: the recognition unit 11 that recognizes a character included in an input image by using each of a plurality of character recognition models different from each other; the determination unit 12 that determines any of the plurality of recognition results as a most likely recognition result by using the determination model based on the recognition result by each of the plurality of character recognition models and image feature information indicating a feature of the input image; the revision unit 13 that revises the most likely recognition result based on a revision operation by the user; and the retraining unit 14 that retrains the determination model by referring to training data including information indicating a revision content for the most likely recognition result, a plurality of recognition results, and image feature information. Here, the development cost related to retraining of the determination model that does not include character recognition processing itself can be expected to be lower than the development cost related to retraining of the character recognition model that includes character recognition processing. Therefore, according to the character recognition system 1, since the determination model is retrained without retraining the character recognition model, the development cost related to the retraining can be reduced. In the retraining of the determination model, it is not necessary to refer to an input image that is necessary for retraining of the character recognition model and that can include personal information. In the retraining of the determination model, image feature information having a smaller capacity than the input image is referred to. Therefore, according to the character recognition system 1, since the determination model is retrained without retraining the character recognition model, the management cost of the training data necessary for retraining can be reduced. As a result, according to the character recognition system 1, it is possible to provide a technique for achieving retraining of a character recognition system using a plurality of character recognition models at low cost.

In the character recognition system disclosed in JP 2024-3769 A, it is considered that each character recognition model has been learned in such a way as to conform to a document to be recognized. Therefore, performance degradation may occur due to a change, an increase, or the like of a recognition target after operation. However, there is a problem that retraining of the character recognition model requires a development cost. Since an image indicating the correction result referred to in the retraining has a large data capacity and may include personal information, there is a problem that the management cost related to storage is high. Therefore, a technique for achieving retraining of a character recognition system using a plurality of character recognition models at low cost is required.

According to an exemplary aspect of the present disclosure, there is an exemplary effect that a technique for achieving retraining of a character recognition system using a plurality of character recognition models at low cost can be provided.

### Flow of Character Recognition Method S1

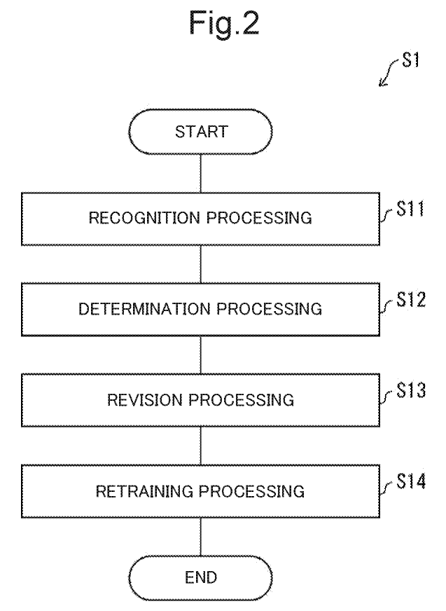

A flow of a character recognition method S1 is described with reference to FIG. 2. For example, if the character recognition system 1 includes at least one processor, the character recognition system 1 executes the character recognition method S1. FIG. 2 is a flowchart illustrating a flow of the character recognition method S1. As illustrated in FIG. 2, the character recognition method S1 includes recognition processing S11, determination processing S12, revision processing S13, and retraining processing S14.

In the recognition processing S11, at least one processor (for example, the recognition unit 11) recognizes a character included in the input image using each of a plurality of character recognition models different from each other. Since the recognition processing S11 is described similarly to the recognition unit 11, detailed description thereof will not be repeated.

In the determination processing S12, based on the recognition result by each of the plurality of character recognition models and the image feature information indicating the feature of the input image, at least one processor (for example, the determination unit 12) determines any of the plurality of recognition results as a most likely recognition result using a determination model. Since the determination processing S12 is described similarly to the determination unit 12, detailed description thereof will not be repeated.

In the revision processing S13, at least one processor (for example, the revision unit 13) revises the most likely recognition result based on the revision operation by the user. Since the revision processing S13 is described similarly to the revision unit 13, detailed description thereof will not be repeated.

In the retraining processing S14, at least one processor (for example, the retraining unit 14) retrains the determination model by referring to training data including information indicating a revision content for a most likely recognition result, a plurality of recognition results, and image feature information. Since the retraining processing S14 is described similarly to the retraining unit 14, detailed description thereof will not be repeated.

### Effect of Character Recognition Method S1

As described above, the character recognition method S1 adopts a configuration including: the recognition processing S11 of recognizing a character included in an input image by at least one processor using each of a plurality of character recognition models different from each other; the determination processing S12 of determining any of the plurality of recognition results as a most likely recognition result by at least one processor using the determination model based on the recognition result by each of the plurality of character recognition models and image feature information indicating a feature of the input image; the revision processing S13 of revising the most likely recognition result based on a revision operation by the user by at least one processor; and the retraining processing S14 of retraining the determination model by referring to training data including information indicating a revision content for the most likely recognition result, a plurality of recognition results, and image feature information by at least one processor. Therefore, according to the character recognition method S1, effects similar to those of the character recognition system 1 can be obtained.

### SECOND EXAMPLE EMBODIMENT

A second example embodiment that is an example of the example embodiments of the present disclosure is described in detail with reference to the drawings. Components having the same functions as the components described in the above-described example embodiment are denoted by the same reference signs, and descriptions thereof are omitted as appropriate. An application range of each technique adopted in the present example embodiment is not limited to the present example embodiment. That is, each technique adopted in the present example embodiment can also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Character Recognition System 1A

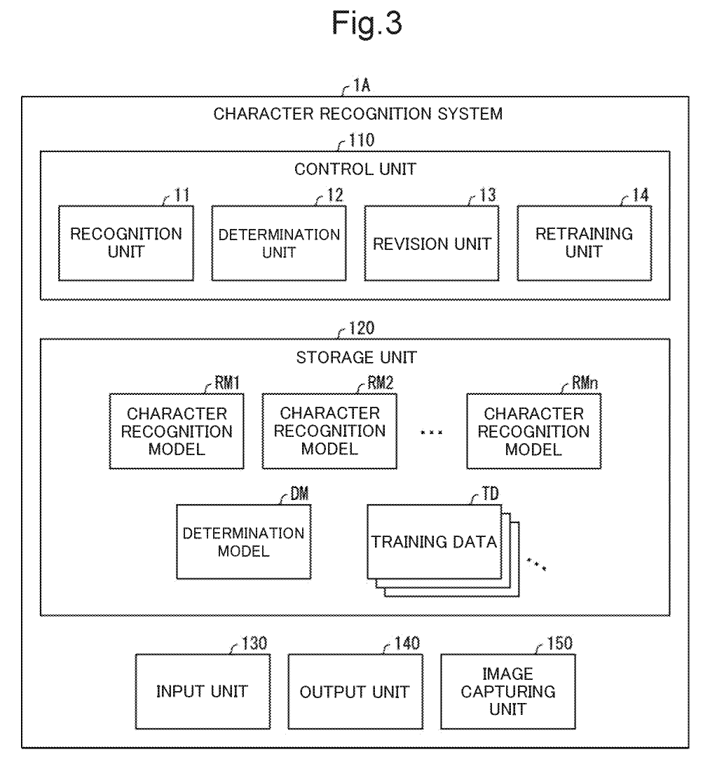

A configuration of a character recognition system 1A is described with reference to FIG. 3. FIG. 3 is a block diagram illustrating a configuration of the character recognition system 1A. The character recognition system 1A includes a control unit 110, a storage unit 120, an input unit 130, an output unit 140, and an image capturing unit 150.

### Image Capturing Unit 150

The image capturing unit 150 includes an image capturing device such as a scanner or a camera that generates an image obtained by capturing an object using an image sensor. Instead of being built in the character recognition system 1A, at least a part of the image capturing unit 150 may be connected to the character recognition system 1A as a peripheral device or may be built in or connected to a terminal (not illustrated) communicably connected to the character recognition system 1A.

### Input Unit 130 And Output Unit 140

The input unit 130 includes an input device such as a keyboard, a mouse, a microphone, or a touch pad. The output unit 140 includes an output device such as a display and a speaker.

The input unit 130 and the output unit 140 may include an input/output device integrally formed as a touch panel or the like. Instead of being built in the character recognition system 1A, at least one of either or both of the input unit 130 and the output unit 140 may be connected to the character recognition system 1A as a peripheral device or may be built in or connected to a terminal (not illustrated) communicably connected to the character recognition system 1A.

### Storage Unit 120

The storage unit 120 stores various items of data to be referred to by the control unit 110 and various items of data generated by the control unit 110. Instead of being built in the character recognition system 1A, at least a part of the storage unit 120 may be connected to the character recognition system 1A as a peripheral device or may be included in a device (not illustrated) communicably connected to the character recognition system 1A. As an example, the storage unit 120 stores character recognition models RM1, RM2,..., and RMn (n is an integer of 2 or more), a determination model DM, and training data TD. When it is not necessary to particularly distinguish and describe each of the character recognition models RM1, RM2,..., and RMn, each is also simply referred to as the character recognition models RM. The storage unit 120 can store a plurality of pieces of training data TD. The training data TD including information obtained regarding a certain input image IMG is counted as one. In other words, the storage unit 120 can store the training data TD obtained for each of the plurality of input images IMG. Details of these data will be described later.

### Control Unit 110

The control unit 110 integrally controls each unit of the character recognition system 1A. For example, the control unit 110 includes the recognition unit 11, the determination unit 12, the revision unit 13, and the retraining unit 14.

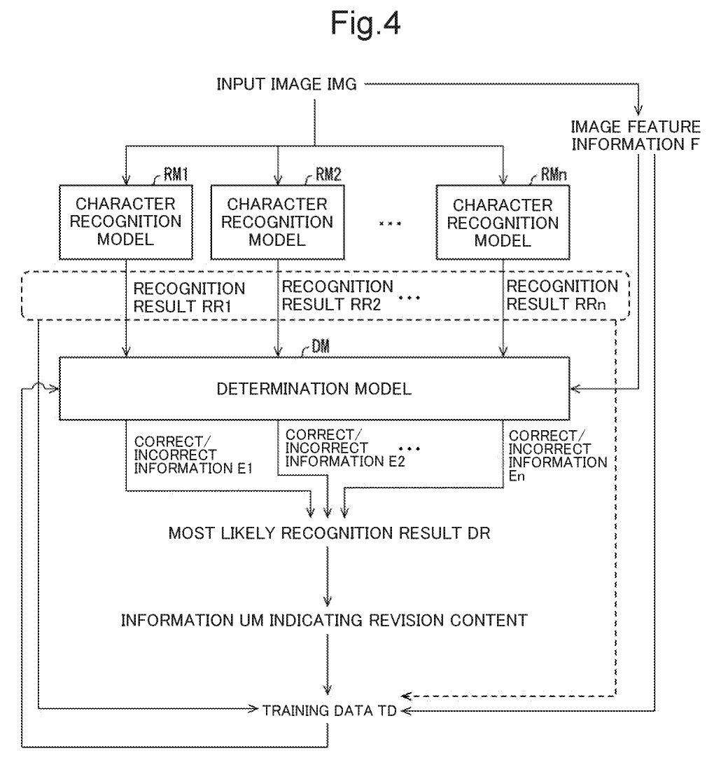

The recognition unit 11 is configured as follows in addition to being configured similarly to the recognition unit 11 included in the character recognition system 1. The recognition unit 11 recognizes characters included in the input image IMG using the plurality of character recognition models RM. A specific example of input and output of the character recognition model RM is described with reference to FIG. 4.

FIG. 4 is a diagram schematically illustrating a specific example of information to be referred to or generated in the character recognition system 1A. As illustrated in FIG. 4, the character recognition model RM1 outputs a recognition result RR1 if the input image IMG is input from the image capturing unit 150. The input image IMG is an image including one or more characters. The character recognition model RM1 includes, for example, a preprocessing unit that performs preprocessing on the input image IMG and a trained model that performs character recognition on the preprocessed input image IMG. The trained model is subjected to machine learning in such a way as to output the recognition result RR1 including character information and a recognition score using the preprocessed input image IMG as an input.

A character recognition model RM2 outputs a recognition result RR2 if the input image IMG is input.

A character recognition model RMn outputs a recognition result RRn if the input image IMG is input. Details of the character recognition models RM2,..., and RMn are described in the same manner as the character recognition model RM1. As a result, the recognition unit 11 obtains the plurality of recognition results RR1, RR2,..., and RRn. When it is not necessary to particularly distinguish and describe each of the recognition results RR1, RR2,..., and RRn, each is also simply referred to as the recognition result RR.

The determination unit 12 is configured as follows in addition to being configured similarly to the determination unit 12 included in the character recognition system 1. The determination unit 12 determines any of the plurality of recognition results RR as the most likely recognition result DR by using the determination model DM. The determination model DM is a model that receives an input of any one of the plurality of recognition results RR and image feature information F as inputs and outputs correct/incorrect information E indicating whether the recognition result RR is correct or incorrect. A specific example of input and output of the determination model DM is described with reference to FIG. 4.

As illustrated in FIG. 4, the determination model DM is subjected to machine learning in such a way as to output correct/incorrect information E1 upon the recognition result RR1 is input, output correct/incorrect information E2 upon the recognition result RR2 is input,..., and output correct/incorrect information En upon the recognition result RRn is input. When it is not necessary to particularly distinguish and describe each piece of the correct/incorrect information E1, E2,..., and En, each is also simply referred to as the correct/incorrect information E.

For example, the correct/incorrect information E includes information indicating “correct” or “incorrect”. “Correct” indicates that the character information included in the recognition result RR is correct. “Incorrect” indicates that the character information included in the recognition result RR is incorrect. The correct/incorrect information E may further include a correct/incorrect score. The correct/incorrect score indicates the probability (certainty factor) that the determination result of “correct” or “incorrect” with respect to the recognition result RR is correct. Alternatively, the recognition score included in a recognition result PR may be adopted as the correct/incorrect score. In this case, the correct/incorrect information E may include information indicating “correct” in a case where the correct/incorrect score is the threshold or greater and may include information indicating “incorrect” in a case where the correct/incorrect score is less than the threshold.

The determination unit 12 outputs the most likely recognition result DR by referring to the correct/incorrect information E output using the determination model DM for each of the plurality of recognition results RR. For example, the determination unit 12 may determine at least one of the recognition results RR in which the correct/incorrect information E indicates “correct” among the plurality of recognition results RR as the most likely recognition result DR.

For example, it is assumed that n=5 in FIG. 4. The correct/incorrect information E1 includes “correct” and the correct/incorrect score of 0.9, the correct/incorrect information E2 includes “incorrect” and the correct/incorrect score of 0.8, the correct/incorrect information E3 includes “correct” and the correct/incorrect score of 0.6, the correct/incorrect information E4 includes “correct” and the correct/incorrect score of 0.5, and the correct/incorrect information E5 includes “incorrect” and the correct/incorrect score of 0.7. In this case, any of the recognition results RR1, RR3, and RR4 relevant to the correct/incorrect information E1, E3, and E4 indicating “correct” is the most likely recognition result DR. For example, if the number of most likely recognition results DR is one, the recognition result RR1 having the largest correct/incorrect score among the recognition results RR1, RR3, and RR4 may be determined as the most likely recognition result DR.

When the plurality of most likely recognition results DR are allowed, for example, a predetermined number (for example, two) of recognition results RR1 and RR3 may be determined as the most likely recognition result DR in descending order of the correct/incorrect score among the recognition results RR1, RR3, and RR4. For example, among the recognition results RR1, RR3, and RR4, the recognition results RR1 and RR3 having a correct/incorrect score equal to or higher than a threshold (for example, 0.6) may be determined as the most likely recognition result DR.

For example, among the recognition results RR1, RR3, and RR4 relevant to the correct/incorrect information E1, E3, and E4 indicating “correct”, the recognition result RR including a larger number of pieces of the same character information may be determined as the most likely recognition result DR. For example, it is assumed that the recognition result RR1 includes character information “12345”, the recognition result RR3 includes character information “12346”, and the recognition result RR4 includes character information “12345”. In this case, the number of recognition results RR1 and RR4 including the same character information “12345” is 2 and is larger than 1 that is the number of recognition results RR3 including the character information “12346”. Therefore, one or both of the recognition results RR1 and RR4 may be the most likely recognition result DR.

The method of determining any of the plurality of recognition results RR as the most likely recognition result DR based on the correct/incorrect information E determined by the determination model DM is not limited to the above-described example.

The determination unit 12 may include the determination score in the most likely recognition result DR. The determination score indicates the probability (certainty factor) of the character information included in the most likely recognition result DR. For example, the determination unit 12 may calculate the determination score based on one or both of the recognition score included in the recognition result RR adopted as the most likely recognition result DR and the correct/incorrect score included in the correct/incorrect information E relevant to the recognition result RR. For example, either the recognition score or the correct/incorrect score may be used as the determination score as it is. The determination score may be calculated by a predetermined calculation formula using the recognition score and the correct/incorrect score.

The revision unit 13 is configured as follows in addition to being configured similarly to the revision unit 13 included in the character recognition system 1. For example, the revision unit 13 may determine whether to accept the user's revision operation for the most likely recognition result DR according to the determination score included in the most likely recognition result DR. For example, if the determination score is less than the threshold, the most likely recognition result DR may be output in a mode in which a revision operation by the user can be accepted, and if the determination score is the threshold or greater, the most likely recognition result DR may be output in a mode in which the revision operation is not accepted.

When a plurality of most likely recognition results DR is determined, and character information included in each most likely recognition result DR is different, the revision unit 13 may accept an operation of selecting any most likely recognition result DR as at least a part of the revision operation.

For example, as illustrated in FIG. 4, revision is performed on the most likely recognition result DR based on the user's revision operation, in such a way that the information UM indicating the revision content is generated. The information UM indicating the revision content includes, for example, unrevised character information and revised character information. The unrevised character information is character information included in the most likely recognition result DR. The revised character information is character information indicating a correct answer input by the user.

The retraining unit 14 is configured as follows in addition to being configured similarly to the retraining unit 14 included in the character recognition system 1. The retraining unit 14 may record the training data TD in the storage unit 120 according to the revision of the most likely recognition result DR and retrain the determination model DM if a predetermined condition regarding the amount of the training data TD recorded in the storage unit 120 is satisfied. The training data TD includes, for example, information UM indicating a revision content for the most likely recognition result DR, the plurality of recognition results RR, and image feature information F. The image feature information F is extracted from the input image IMG. A specific example of the image feature information F is similar to the specific example of the image feature information to be referred to in the character recognition system 1, and thus a detailed description thereof is not repeated. As described above, it is assumed that the training data TD including information obtained for the certain input image IMG is counted as one.

For example, examples of the predetermined condition include, but are not limited to, that the amount of the training data TD exceeds the threshold, that the amount of the training data TD increased from the previous training exceeds the threshold, and that the increase speed of the training data TD exceeds the threshold. As a result, retraining is automatically performed in accordance with the accumulation of the revision content by the user with respect to the most likely recognition result DR, and thus, there is an effect that labor of the user related to retraining is reduced.

The retraining unit 14 may retrain the determination model DM according to an operation of the user instructing retraining of the determination model DM. As a result, there is an effect that, if the user feels that the performance of character recognition has deteriorated, the user can intentionally execute retraining to improve the performance. There is an effect that if the recognition target changes or increases, the user can intentionally execute retraining to match the performance of character recognition with the change or increase.

The retraining unit 14 may record the training data TD in the storage unit 120 according to an operation of the user instructing recording of the training data TD. As a result, the user can determine whether to use the revision content for the most likely recognition result DR for retraining of the determination model DM. For example, it is assumed that there is a period in which both new and old recognition targets exist in accordance with a change in a recognition target (for example, form design). The user can take measures such as not instructing to record the training data TD for the revision content for the most likely recognition result DR of the old recognition target and instructing to record the training data TD for the revision content for the new most likely recognition result DR of the recognition target. As a result, there is an effect that the management cost of the training data TD is reduced since the training data TD including the information UM indicating the revision content considered to be useful for retraining by the user is stored and the other training data is not stored.

### Flow of Character Recognition Method S1A

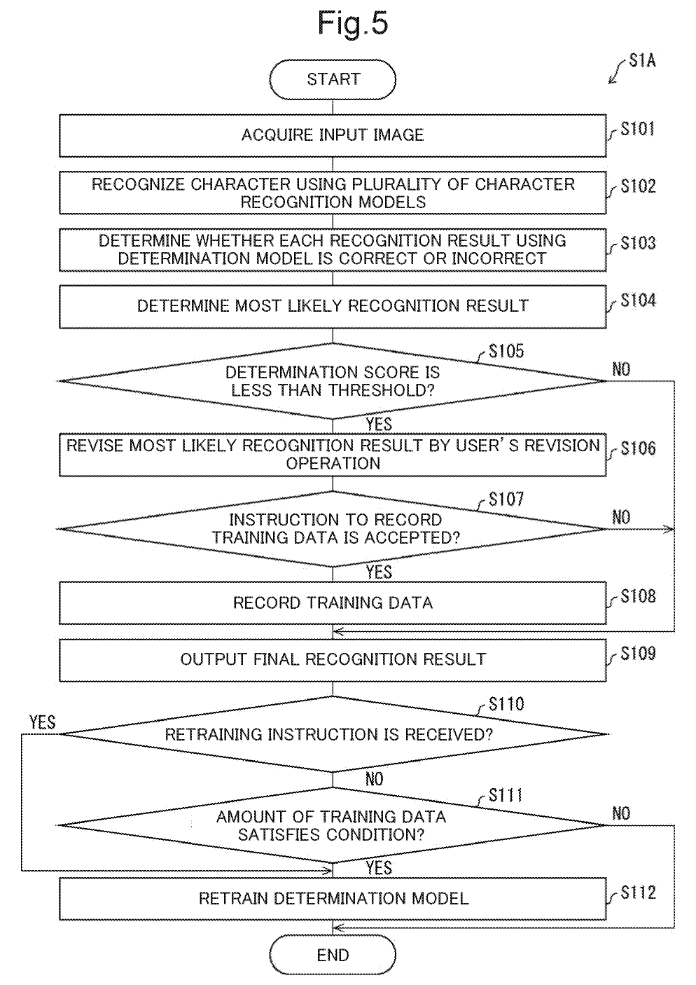

The character recognition system 1A configured as described above executes a character recognition method S1A. FIG. 5 is a flowchart illustrating a flow of the character recognition method S1A. As illustrated in FIG. 5, the character recognition method S1A includes steps S101 to S112.

In step S101, the recognition unit 11 acquires the input image IMG from the image capturing unit 150.

Step S102 is an example of the recognition processing. In step S102, the recognition unit 11 recognizes characters included in the input image IMG using each of the plurality of character recognition models RM. Specifically, the recognition unit 11 obtains the recognition result RR output from each of the character recognition models RM by inputting the input image IMG to each of the plurality of character recognition models RM.

Steps S103 to S104 are an example of the determination processing. In step S103, the determination unit 12 determines whether each recognition result RR is correct or incorrect using the determination model DM. Specifically, the determination unit 12 generates the image feature information F based on the input image IMG. The determination unit 12 obtains correct/incorrect information E by inputting the recognition result RR and the image feature information F to the determination model DM for each of the plurality of recognition results RR.

In step S104, the determination unit 12 refers to the correct/incorrect information E relevant to each recognition result RR and determines any of the plurality of recognition results RR as the most likely recognition result DR. The determination unit 12 calculates a determination score and includes the calculated determination score in the most likely recognition result DR.

Steps S105 to S106 are an example of the revision processing. In step S105, the revision unit 13 determines whether the determination score is less than the threshold. When it is determined as No in step S105, the following step S109 is executed. When it is determined as Yes in step S105, the next step S106 is executed.

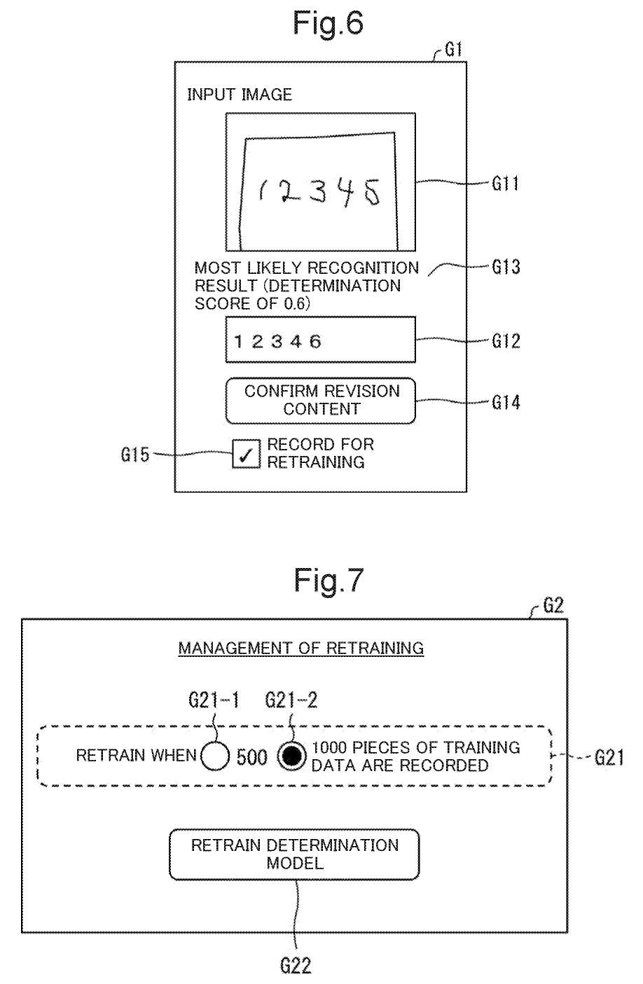

In step S106, the revision unit 13 revises the character information included in the most likely recognition result DR based on the revision operation of the user. When the user's revision operation has not been accepted, step S106 is omitted. FIG. 6 is a diagram illustrating an example of a screen displayed on the output unit 140 (for example, a display device such as a display) in step S106.

As illustrated in FIG. 6, a screen example G1 includes an area G11 including the input image IMG, a text field G12 including character information “12346” included in the most likely recognition result DR, an area G13 including the determination score, and operation objects G14 and G15. With the area G11 and the text field G12, the user can recognize the most likely recognition result DR for the input image IMG. In this example, since the determination score of 0.6 included in the area G13 is less than the threshold value (for example, 0.7), the text field G12 is displayed in a mode capable of accepting the revision operation by the user.

For example, if the character information included in the input image IMG is originally “12345”, the user can perform an operation of revising the character information “12346” included in the text field G12 to “12345”.

The operation object G14 accepts an operation of confirming the revision content in the text field G12. The operation object G15 accepts an operation instructing whether to record the confirmed revision content for retraining. For example, the operation object G15 functions as a toggle button that transitions between an on state (recording for retraining) and an off state (not recording for retraining) every time an operation is accepted. When an operation on the operation object G14 is accepted with the operation object G15 in an on state, the training data TD including the information UM indicating the confirmed revision content is recorded in the storage unit 120.

In step S107, the retraining unit 14 determines whether an instruction to record the training data TD has been accepted. For example, in the screen example G1 of FIG. 6, it is determined whether an operation on the operation object G14 is accepted with the operation object G15 in an on state.

When it is determined as No in step S107, the following step S109 is executed. When it is determined as Yes in step S107, the next step S108 is executed.

In step S108, the retraining unit 14 generates the information UM indicating the revision content based on the revision operation by the user in step S106. The retraining unit 14 generates the training data TD including the information UM indicating the revision content, the plurality of recognition results RR, and the image feature information F and records the generated training data TD in the storage unit 120.

Step S109 is executed subsequent to step S108 or if it is determined as No in step S105 or S107. In step S109, the control unit 110 outputs the final recognition result. When step S106 has been executed, the final recognition result includes revised character information in which the character information included in the most likely recognition result DR is revised. The final recognition result includes character information included in the most likely recognition result DR in a case where step S106 has not been executed. The output destination of the final recognition result may be the output unit 140, may be the storage unit 120, or may be both.

Steps S110 to S112 are an example of the retraining processing. Note that steps S110 to S112 are not necessarily executed subsequent to steps S101 to S109 and may be executed at an arbitrary time point asynchronously with steps S101 to S109.

In step S110, the retraining unit 14 determines whether an operation of the user instructing retraining has been accepted. FIG. 7 is a diagram illustrating an example of a screen displayed on the output unit 140 (for example, a display device such as a display) in step S110.

As illustrated in FIG. 7, a screen example G2 illustrates an example of a screen for managing retraining. The screen example G2 includes an area G21 and an operation object G22. The area G21 is an area for designating a condition regarding the amount of training data TD on which retraining is to be executed. The area G21 includes operation objects G21-1 and G21-2. The operation objects G21-1 and G21-2 function as radio buttons that enable selection of either 500 or 1000 as the threshold of the amount of the training data TD. For example, if the operation object G21-1 is selected, a condition that the amount of the training data TD exceeds 500 is set as a condition for executing retraining. For example, if the operation object G21-2 is selected, a condition that the amount of the training data TD exceeds 1000 is set as a condition for executing retraining. The amount of the training data TD may be the number or the data capacity.

The operation object G22 accepts an operation of the user instructing retraining of the determination model DM. When the operation on the operation object G22 is accepted, it is determined as Yes in step S110.

When it is determined as Yes in step S110, the following step S112 is executed. When it is determined as No in step S110, the next step S111 is executed.

In step S111, the retraining unit 14 determines whether the amount of the training data TD recorded in the storage unit 120 satisfies a predetermined condition. For example, if “1000” is set in the screen example G2 of FIG. 7, it is determined whether the amount of the training data TD recorded in the storage unit 120 exceeds 1000. If it is determined as No in step S111, the character recognition method S1A ends without executing the next step S112.

When it is determined as Yes in step S110 or S111, step S112 is executed. In step S112, the retraining unit 14 retrains the determination model DM using the training data TD recorded in the storage unit 120. Thus, the character recognition method S1A ends.

### Effect of Character Recognition System 1A

As described above, the character recognition system 1A adopts a configuration in which the determination model DM is a model that receives an input of any one of the plurality of recognition results RR and the image feature information F and outputs the correct/incorrect information E indicating whether the recognition result RR is correct or incorrect, and the determination unit 12 refers to the correct/incorrect information E output by using the determination model DM for each of the plurality of recognition results RR and outputs the most likely recognition result DR. Therefore, according to the character recognition system 1A, in addition to the effect exhibited by the character recognition system 1, it is possible to obtain an effect of accurately deriving the most likely recognition result DR using the plurality of recognition results RR.

The character recognition system 1A adopts a configuration that the retraining unit 14 records the training data TD in the storage unit 120 according to the revision of the most likely recognition result DR and retrains the determination model DM if a predetermined condition regarding the amount of the training data TD recorded in the storage unit 120 is satisfied. Therefore, according to the character recognition system 1A, in addition to the effects exhibited by the character recognition system 1, retraining is automatically (that is, a user's instruction is not necessary) performed in accordance with accumulation of revision contents by the user for the most likely recognition result DR, and thus, it is possible to obtain an effect that labor of the user related to retraining is reduced.

The character recognition system 1A adopts a configuration in which the retraining unit 14 retrains the determination model DM according to an operation of the user instructing retraining of the determination model DM. Therefore, according to the character recognition system 1A, in addition to the effect exhibited by the character recognition system 1, it is possible to obtain an effect that the user can intentionally execute retraining at a desired timing such as if the user feels that the performance of character recognition has deteriorated, or if the recognition target has changed or increased.

The character recognition system 1A adopts a configuration in which the retraining unit 14 records the training data TD in the storage unit 120 according to an operation of the user instructing recording of the training data TD. Therefore, according to the character recognition system 1A, in addition to the effect exhibited by the character recognition system 1, the training data TD that the user has instructed to record as being useful for retraining or the like is recorded, and data that is not instructed is not recorded. Therefore, it is possible to obtain the effect in which the management cost of the training data TD is reduced.

### THIRD EXAMPLE EMBODIMENT

A third example embodiment that is an example of the example embodiments of the present disclosure is described in detail with reference to the drawings. Components having the same functions as the components described in the above-described example embodiments are denoted by the same reference signs, and descriptions thereof are omitted as appropriate. An application range of each technique adopted in the present example embodiment is not limited to the present example embodiment. That is, each technique adopted in the present example embodiment can also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Character Recognition System 1B

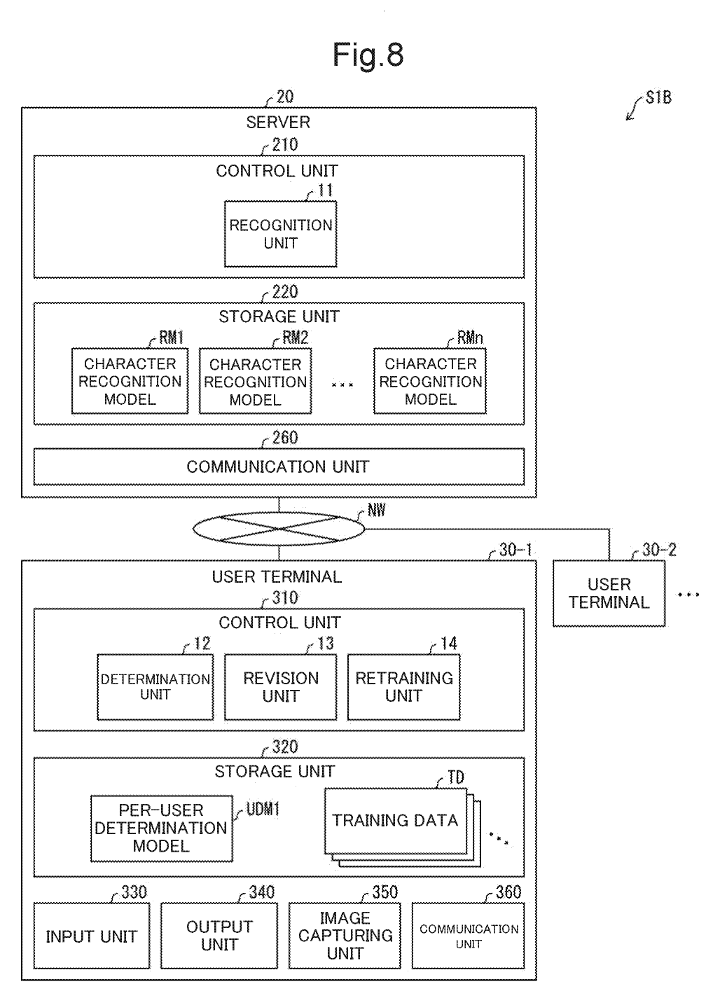

A configuration of a character recognition system 1B is described with reference to FIG. 8. FIG. 8 is a block diagram illustrating a configuration of the character recognition system 1B. As illustrated in FIG. 8, the character recognition system 1B includes a server 20 and user terminals 30-1, 30-2,.... When it is not necessary to particularly distinguish and describe each of the user terminals 30-1 and 30-2, each is also simply referred to as a user terminal 30. Although FIG. 8 illustrates the plurality of user terminals 30, the number of user terminals 30 included in the character recognition system 1B may be one. The server 20 and each user terminal 30 are communicably connected via a network NW. The network NW includes a wireless local area network (LAN), a wired LAN, a wide area network (WAN), a public network, a mobile data communication network, or a combination of some or all of the networks but is not limited thereto. However, the configuration of the network NW is not limited to the above-described example.

### Configuration of Server 20

As illustrated in FIG. 8, the server 20 includes a control unit 210, a storage unit 220, and a communication unit 260.

### Communication Unit 260

The communication unit 260 communicates with a device outside the server 20. The communication unit 260 transmits data supplied from the control unit 210 to an external device and supplies data received from the external device to the control unit 210. As an example, the communication unit 260 communicates with each user terminal 30. The data received by the communication unit 260 from each user terminal 30 can include the input image IMG obtained by photographing the recognition target. The data transmitted from the communication unit 260 to the user terminal 30 may include a recognition result by each of the plurality of character recognition models RM.

### Storage Unit 220

The storage unit 220 stores various items of data to be referred to by the control unit 210 and various items of data generated by the control unit 210. At least a part of the storage unit 220 may be connected to the server 20 as a peripheral device instead of being built in the server 20 or may be included in a device (not illustrated) communicably connected to the server 20. As an example, the storage unit 220 stores the plurality of character recognition models RM (RM1, RM2,..., and RMn).

### Control Unit 210

The control unit 210 integrally controls each unit of the server 20. For example, the control unit 210 includes the recognition unit 11.

The recognition unit 11 is configured as follows in addition to being configured similarly to the recognition unit 11 included in the character recognition system 1 or 1A. The recognition unit 11 recognizes a character included in the input image IMG acquired in the user terminal 30 by using each of the plurality of character recognition models RM. A specific example of the input and output of the character recognition model RM is as described with reference to FIG. 4, and thus a detailed description thereof is not repeated. As a result, the plurality of recognition results RR are obtained in the server 20 for the input image IMG acquired in the user terminal 30. For example, upon receiving a character recognition request including the input image IMG from any of the plurality of user terminals 30, the recognition unit 11 transmits the plurality of recognition results RR for the input image IMG to the user terminal 30.

### Configuration of User Terminal 30-1

As illustrated in FIG. 8, the user terminal 30-1 includes a control unit 310, a storage unit 320, an input unit 330, an output unit 340, an image capturing unit 350, and a communication unit 360. The input unit 330, the output unit 340, and the image capturing unit 350 are configured similarly to the respective units having the same names included in the character recognition system 1A, and thus, a detailed description thereof is not repeated. At least a part or all of the storage unit 320, the input unit 330, the output unit 340, and the image capturing unit 350 may be connected to the user terminal 30-1 as a peripheral device instead of being built in the user terminal 30-1.

### Communication Unit 360

The communication unit 360 communicates with a device outside the user terminal 30-1. The communication unit 360 transmits data supplied from the control unit 310 to an external device and supplies data received from the external device to the control unit 310. As an example, the communication unit 360 communicates with the server 20. The data transmitted from the communication unit 360 to the server 20 may include the input image IMG obtained by photographing the recognition target. The data received from the server 20 by the communication unit 360 may include the recognition result RR by each of the plurality of character recognition models RM.

### Storage Unit 320

The storage unit 320 stores various items of data to be referred to by the control unit 310 and various items of data generated by the control unit 310. As an example, the storage unit 320 stores a per-user determination model UDM1 and the training data TD. The storage unit 320 can store the plurality of pieces of training data TD. The per-user determination model UDM1 is associated with a user U1 of the user terminal 30-1. The per-user determination model UDM1 is configured similarly to the determination model DM included in the character recognition system 1A except that the per-user determination model UDM1 is associated with the user U1.

### Control Unit 310

The control unit 310 integrally controls each unit of the user terminal 30-1. For example, the control unit 310 includes the determination unit 12, the revision unit 13, and the retraining unit 14.

The determination unit 12 is configured as follows in addition to being configured similarly to the determination unit 12 included in the character recognition system 1 or 1A. The determination unit 12 determines the most likely recognition result DR using the per-user determination model UDM1 associated with the user U1 of the user terminal 30-1 based on the plurality of recognition results RR recognized in the server 20 and the image feature information F. A specific example of the input/output of the per-user determination model UDM1 is similar to that of the determination model DM described with reference to FIG. 4, and thus, a detailed description thereof is not repeated.

For example, the determination unit 12 acquires the input image IMG and transmits a character recognition request including the acquired input image IMG to the server 20, thereby receiving the plurality of recognition results RR from the server 20. The determination unit 12 generates the image feature information F regarding the acquired input image IMG.

The determination unit 12 generates the most likely recognition result DR along the per-user determination model UDM1 based on the plurality of recognition results RR received from the server 20 and the generated image feature information F.

The revision unit 13 is configured similarly to the revision unit 13 included in the character recognition system 1 or 1A.

The retraining unit 14 is configured as follows in addition to being configured similarly to the retraining unit 14 included in the character recognition system 1 or 1A. The retraining unit 14 retrains the per-user determination model UDM1.

### Configuration of Another User Terminal 30

Another user terminal 30 (for example, the user terminal 30-2) is configured in substantially the same manner as the user terminal 30-1. However, the difference is that the storage unit 320 stores a per-user determination model UDM associated with a user U of the user terminal 30. The determination unit 12 and the retraining unit 14 of the user terminal 30 operate by using the per-user determination model UDM.

For example, a configuration of the user terminal 30-2 is described as an example. The storage unit 320 included in the user terminal 30-1 stores a per-user determination model UDM2 associated with a user U2 of the user terminal 30-2. The determination unit 12 included in the user terminal 30-2 makes a determination by using the per-user determination model UDM2. The retraining unit 14 included in the user terminal 30-2 retrains the per-user determination model UDM2.

The per-user determination models UDM1 and UDM2 may be different trained models so as to match recognition targets unique to the users U1 and U2 from the beginning of introduction or may be the same model from the beginning of introduction. Even if the models are the same at the beginning of introduction, the per-user determination models UDM1 and UDM2 are individually retrained in the user terminals 30-1 and 30-2 so as to be matched with recognition targets specific to the users U1 and U2.

### Flow of Operation of Character Recognition System 1B

The character recognition system 1B executes the character recognition method

S1A substantially similarly to the character recognition system 1A. However, the following points are different.

Steps S101, and S103 to S112 are executed by the user terminal 30, and step S102 is executed by the server 20. In step S103, the per-user determination model UDM is used instead of the determination model DM. In step S112, the per-user determination model UDM is retrained instead of the determination model DM.

### Effects of Character Recognition System 1B

As described above, the character recognition system 1A adopts a configuration of including the server 20 and the user terminal 30, in which the server 20 includes the recognition unit 11, the user terminal 30 includes the determination unit 12, the revision unit 13, and the retraining unit 14, the recognition unit 11 recognizes the character included in the input image IMG acquired in the user terminal 30 by using each of the plurality of character recognition models RM, the determination unit 12 determines the most likely recognition result DR using the per-user determination model UDM indicating the determination model associated with the user U of the user terminal 30 based on the plurality of recognition results RR recognized in the server 20 and the image feature information F, and the retraining unit 14 retrains the per-user determination model UDM. Therefore, according to the character recognition system 1B, the plurality of character recognition models RM requiring development costs can be shared by a plurality of users, and the determination model that can be retrained at low cost can be provided for each user. As a result, in addition to the effects of the character recognition systems 1 and 1A, an effect can be exhibited that the character recognition system capable of retraining according to a recognition target specific to the user can be introduced at low cost.

### EXEMPLARY IMPLEMENTATION BY SOFTWARE

Some or all of the functions of the respective devices configuring the character recognition systems 1, 1A, and 1B may be achieved by hardware such as an integrated circuit (IC chip) or may be achieved by software.

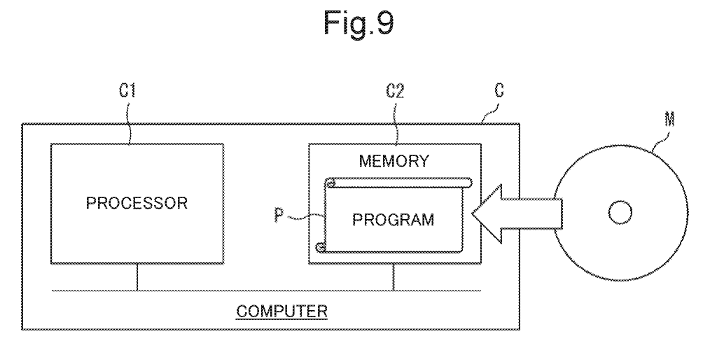

In the latter case, each of the above devices is implemented by, for example, a computer that executes commands of a program, that is software for implementing each function. FIG. 9 illustrates an example of such a computer (hereinafter, referred to as a computer C). FIG. 9 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes the program P, thereby implementing the functions of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof, or the like can be used. As the memory C2, for example, a flash memory, a hard disk drive (HDD), a solid state drive (SSD), or a combination thereof, or the like can be used.

The computer C may further include a random access memory (RAM) for loading the program P at the time of execution and temporarily storing various items of data. The computer C may further include a communication interface for transmitting and receiving data with another device. The computer C may further include an input/output interface for connecting input/output equipment such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P may be transmitted via a transmission medium. Examples of such a transmission medium may include a communication network and a broadcast wave. The computer C can also acquire the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### SUPPLEMENTARY INFORMATION A

The present disclosure includes techniques described in the following Supplementary Notes. However, the present disclosure is not limited to the techniques described in the following Supplementary Notes, and various modifications may be made within the scope described in the claims.

### Supplementary Note A1

A character recognition system including:

recognition means for recognizing a character included in an input image by using each of a plurality of character recognition models different from each other;

determination means for determining any of a plurality of recognition results as a most likely recognition result by using a determination model based on the recognition result by each of the plurality of character recognition models and image feature information indicating a feature of the input image;

revision means for revising the most likely recognition result based on a revision operation by a user; and

retraining means for retraining the determination model by referring to training data including information indicating a revision content for the most likely recognition result, the plurality of recognition results, and the image feature information.

### Supplementary Note A2

The character recognition system according to supplementary note A1,

in which the determination model is a model that outputs correct/incorrect information indicating whether the recognition result is correct or incorrect by taking as input any one of the plurality of recognition results and the image feature information, and

the determination means refers to correct/incorrect information output by using the determination model for each of the plurality of recognition results and outputs the most likely recognition result.

### Supplementary Note A3

The character recognition system according to supplementary note A1 or A2, in which the retraining means records the training data according to revision of the most likely recognition result in a storage unit and retrains the determination model if a predetermined condition regarding an amount of the training data recorded in the storage unit is satisfied.

### Supplementary Note A4

The character recognition system according to any one of supplementary notes A1 to A3, in which the retraining means retrains the determination model according to an operation of the user instructing retraining of the determination model.

### Supplementary Note A5

The character recognition system according to any one of supplementary notes A1 to A4, in which the retraining means records the training data in a storage unit according to an operation of the user instructing recording of the training data.

### Supplementary Note A6

The character recognition system according to any one of supplementary notes A1 to A5, further including:

a server; and a user terminal,

in which the server includes the recognition means,

the user terminal includes the determination means, the revision means, and the retraining means,

the recognition means recognizes a character included in the input image acquired in the user terminal by using each of the plurality of character recognition models,

the determination means determines the most likely recognition result by using a per-user determination model indicating the determination model associated with a user of the user terminal based on the plurality of recognition results recognized in the server and the image feature information, and

the retraining means retrains the per-user determination model.

### SUPPLEMENTARY INFORMATION B

The present disclosure includes techniques described in the following Supplementary Notes. However, the present disclosure is not limited to the techniques described in the following Supplementary Notes, and various modifications may be made within the scope described in the claims.

### Supplementary Note B1

A character recognition method including:

recognition processing of recognizing a character included in an input image by using each of a plurality of character recognition models different from each other by at least one processor;

determination processing of determining any of a plurality of recognition results as a most likely recognition result by using a determination model based on the recognition result by each of the plurality of character recognition models and image feature information indicating a feature of the input image by the at least one processor;

revision processing of revising the most likely recognition result based on a revision operation by a user by the at least one processor; and

retraining processing of retraining the determination model by referring to training data including information indicating a revision content for the most likely recognition result, the plurality of recognition results, and the image feature information, by the at least one processor.

### Supplementary Note B2

The character recognition method according to supplementary note B1,

in which the determination model is a model that outputs correct/incorrect information indicating whether the recognition result is correct or incorrect by inputting any one of the plurality of recognition results and the image feature information, and

in the determination processing, the at least one processor refers to correct/incorrect information output by using the determination model for each of the plurality of recognition results and outputs the most likely recognition result.

### Supplementary Note B3

The character recognition method according to supplementary note B1 or B2, in which in the retraining processing, the at least one processor records the training data according to revision of the most likely recognition result in a storage unit and retrains the determination model if a predetermined condition regarding an amount of the training data recorded in the storage unit is satisfied.

### Supplementary Note B4

The character recognition method according to any one of supplementary note B1 to B3, in which, in the retraining processing, the at least one processor retrains the determination model according to an operation of the user instructing retraining of the determination model.

### Supplementary Note B5

The character recognition method according to any one of supplementary notes B1 to B4, in which, in the retraining processing, the at least one processor records the training data in a storage unit according to an operation of the user instructing recording of the training data.

### Supplementary Note B6

The character recognition method according to any one of supplementary notes B1 to B5,

in which the recognition processing is executed by at least one processor included in the server,

the determination processing, the revision processing, and the retraining processing are executed by at least one processor included in a user terminal,

in the recognition processing, the at least one processor included in the server recognizes a character included in an input image acquired in the user terminal by using the plurality of character recognition models,

in the determination processing, the at least one processor included in the user terminal determines the most likely recognition result by using a per-user determination model indicating the determination model associated with a user of the user terminal based on the plurality of recognition results recognized in the server and the image feature information, and

in the retraining processing, the at least one processor included in the user terminal retrains the per-user determination model.

### SUPPLEMENTARY INFORMATION C

The present disclosure includes techniques described in the following Supplementary Notes. However, the present disclosure is not limited to the techniques described in the following Supplementary Notes, and various modifications may be made within the scope described in the claims.

### Supplementary Note C1

A character recognition program causing a computer to function as a character recognition system, the program causing the computer to function as:

recognition means for recognizing a character included in an input image by using each of a plurality of character recognition models different from each other;

determination means for determining any of a plurality of recognition results as a most likely recognition result by using a determination model based on the recognition result by each of the plurality of character recognition models and image feature information indicating a feature of the input image;

revision means for revising the most likely recognition result based on a revision operation by a user; and

retraining means for retraining the determination model by referring to training data including information indicating a revision content for the most likely recognition result, the plurality of recognition results, and the image feature information.

### Supplementary Note C2

The character recognition program according to supplementary note C1,

in which the determination model is a model that outputs correct/incorrect information indicating whether the recognition result is correct or incorrect by inputting any one of the plurality of recognition results and the image feature information, and

the determination means refers to correct/incorrect information output by using the determination model for each of the plurality of recognition results and outputs the most likely recognition result.

### Supplementary Note C3

The character recognition program according to supplementary note C1 or C2, in which the retraining means records the training data according to revision of the most likely recognition result in a storage unit and retrains the determination model if a predetermined condition regarding an amount of the training data recorded in the storage unit is satisfied.

### Supplementary Note C4

The character recognition program according to any one of supplementary notes C1 to C3, in which the retraining means retrains the determination model according to an operation of the user instructing retraining of the determination model.

### Supplementary Note C5

The character recognition program according to any one of supplementary notes C1 to C4, in which the retraining means records the training data in a storage unit according to an operation of the user instructing recording of the training data.

### Supplementary Note C6

The character recognition program according to any one of supplementary notes C1 to C5,

in which a server is caused to function as the recognition means,

a user terminal is caused to function as the determination means, the revision means, and the retraining means,

the recognition means recognizes a character included in the input image acquired in the user terminal by using each of the plurality of character recognition models,

the determination means determines the most likely recognition result by using a per-user determination model indicating the determination model associated with a user of the user terminal based on the plurality of recognition results recognized in the server and the image feature information, and

the retraining means retrains the per-user determination model.

### SUPPLEMENTARY INFORMATION D

The present disclosure includes techniques described in the following Supplementary Notes. However, the present disclosure is not limited to the techniques described in the following Supplementary Notes, and various modifications may be made within the scope described in the claims.

### Supplementary Note D1

A character recognition system includes at least one processor, and the at least one processor executes:

recognition processing of recognizing a character included in an input image by using each of a plurality of character recognition models different from each other;

determination processing of determining any of a plurality of recognition results as a most likely recognition result by using a determination model based on the recognition result by each of the plurality of character recognition models and image feature information indicating a feature of the input image;

revision processing of revising the most likely recognition result based on a revision operation by a user; and

retraining processing of retraining the determination model by referring to training data including information indicating a revision content for the most likely recognition result, the plurality of recognition results, and the image feature information.

The character recognition system may further include a memory. The memory may store a program for causing the at least one processor to execute each of the processing.

### Supplementary Note D2

The character recognition system according to supplementary note D1,

in which the determination model is a model that outputs correct/incorrect information indicating whether the recognition result is correct or incorrect by taking as input any one of the plurality of recognition results and the image feature information, and

in the determination processing, the at least one processor refers to correct/incorrect information output by using the determination model for each of the plurality of recognition results and outputs the most likely recognition result.

### Supplementary Note D3

The character recognition system according to supplementary note D1 or D2, in which in the retraining processing, the at least one processor records the training data according to revision of the most likely recognition result in a storage unit and retrains the determination model in a case where a predetermined condition regarding an amount of the training data recorded in the storage unit is satisfied.

### Supplementary Note D4

The character recognition system according to any one of supplementary note D1 to D3, in which, in the retraining processing, the at least one processor retrains the determination model according to an operation of the user instructing retraining of the determination model.

### Supplementary Note D5

The character recognition system according to any one of supplementary notes D1 to D4, in which, in the retraining processing, the at least one processor records the training data in a storage unit according to an operation of the user instructing recording of the training data.

### Supplementary Note D6

The character recognition system according to any one of supplementary notes D1 to D5, further including:

a server; and a user terminal,

in which the recognition processing is executed by at least one processor included in the server,

the determination processing, the revision processing, and the retraining processing are executed by at least one processor included in a user terminal,

in the recognition processing, the at least one processor included in the server recognizes a character included in an input image acquired in the user terminal by using the plurality of character recognition models,

in the determination processing, the at least one processor included in the user terminal determines the most likely recognition result by using a per-user determination model indicating the determination model associated with a user of the user terminal based on the plurality of recognition results recognized in the server and the image feature information, and

in the retraining processing, the at least one processor included in the user terminal retrains the per-user determination model.

### SUPPLEMENTARY INFORMATION E

The present disclosure includes techniques described in the following Supplementary Notes. However, the present disclosure is not limited to the techniques described in the following Supplementary Notes, and various modifications may be made within the scope described in the claims.

### Supplementary Note E1

A non-transitory recording medium that records a character recognition program for causing a computer to function as a character recognition system, the program for causing the computer to execute:

recognition processing of recognizing a character included in an input image by using each of a plurality of character recognition models different from each other;

determination processing of determining any of a plurality of recognition results as a most likely recognition result by using a determination model based on the recognition result by each of the plurality of character recognition models and image feature information indicating a feature of the input image;

revision processing of revising the most likely recognition result based on a revision operation by a user; and

retraining processing of retraining the determination model by referring to training data including information indicating a revision content for the most likely recognition result, the plurality of recognition results, and the image feature information.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A character recognition system comprising:
one or more memories storing instructions; and
one or more processors configured to execute the instructions to:
recognize a character included in an input image by using each of a plurality of character recognition models different from each other;
determine, by using a determination model, any of a plurality of recognition results as a most likely recognition result, based on the recognition result by each of the plurality of character recognition models and image feature information indicating a feature of the input image;
revise the most likely recognition result based on a revision operation by a user; and
retrain the determination model by referring to training data including information indicating a revision content for the most likely recognition result, the plurality of recognition results, and the image feature information.

2. The character recognition system according to claim 1,
wherein the determination model is a model that outputs correct/incorrect information indicating whether the recognition result is correct or incorrect by taking as input any one of the plurality of recognition results and the image feature information, and
the one or more processors are configured to execute the instructions to refer to correct/incorrect information output by using the determination model for each of the plurality of recognition results and output the most likely recognition result.

3. The character recognition system according to claim 1, wherein the one or more processors are configured to execute the instructions to record the training data according to revision of the most likely recognition result in a storage unit and retrain the determination model in a case where a predetermined condition regarding an amount of the training data recorded in the storage unit is satisfied.

4. The character recognition system according to claim 1, wherein the one or more processors are configured to execute the instructions to retrain the determination model according to an operation of the user instructing retraining of the determination model.

5. The character recognition system according to claim 1, wherein the one or more processors are configured to execute the instructions to record the training data in a storage unit according to an operation of the user instructing recording of the training data.

6. The character recognition system according to claim 1, further comprising:
a server; and
a user terminal,
wherein the server includes:
one or more memories storing instructions; and
one or more processors configured to execute the instructions to recognize a character included in an input image by using each of a plurality of character recognition models different from each other;
the user terminal includes:
one or more memories storing instructions; and
one or more processors configured to execute the instructions to:
determine the most likely recognition result by using a per-user determination model indicating the determination model associated with a user of the user terminal based on the plurality of recognition results recognized in the server and the image feature information;
revise the most likely recognition result based on a revision operation by a user; and
retrain the per-user determination model.

7. A character recognition method comprising:
by a computer,
recognizing a character included in an input image by using each of a plurality of character recognition models different from each other;
determining any of a plurality of recognition results as a most likely recognition result by using a determination model based on the recognition result by each of the plurality of character recognition models and image feature information indicating a feature of the input image;
revising the most likely recognition result based on a revision operation by a user; and
retraining the determination model by referring to training data including information indicating a revision content for the most likely recognition result, the plurality of recognition results, and the image feature information.

8. A non-transitory recording medium that records a program causing a computer to function as a character recognition system, the program causing the computer to execute:
recognizing a character included in an input image by using each of a plurality of character recognition models different from each other;
determining any of a plurality of recognition results as a most likely recognition result by using a determination model based on the recognition result by each of the plurality of character recognition models and image feature information indicating a feature of the input image;
revising the most likely recognition result based on a revision operation by a user; and
retraining the determination model by referring to training data including information indicating a revision content for the most likely recognition result, the plurality of recognition results, and the image feature information.
